(19) United States
(12) Patent Application Publication
(10) Pub. No.: US 2025/0061423 A1
(43) Pub. Date: Feb. 20, 2025

(54) Human Capital Economics: Automated infrastructure and method for determining employee life cycle costs with return on investment calculation and decision making framework

(71) Applicant: Maria Scarangella, Tucson, AZ (US)

(72) Inventor: Maria Scarangella, Tucson, AZ (US)

(21) Appl. No.: 18/810,461

(22) Filed: Aug. 20, 2024

Related U.S. Application Data
(60) Provisional application No. 63/533,694, filed on Aug. 20, 2023.

(51) Int. Cl. G06Q 10/105

(52) U.S. Cl. CPC G06Q 10/105

(57) ABSTRACT

An automated computer infrastructure for synthesizing computer data regarding employee life cycle costs for human capital economic analysis and management. A computerized framework receives and processes employee life cycle financial data elements in an automated manner by computer and transforms them into actionable synthesized human resource economic analysis. The computerized framework comprises computer data entry and analysis software adapted for receiving, processing, and transforming individual employee and organizational life cycle financial data elements relating to costs of hire, costs of training & onboarding, and costs of offboarding. The automated computer infrastructure is adapted to transform life cycle financial data elements to, for instance, percentage of recruiter time spent on each of plural employee tiers, recruiter cost per hire for plural employee tiers, hiring salary overhead, salary time costs for hiring, contract cost, cost of training, cost of mentoring, knowledge retention expense, offboarding expense, productivity loss, and cost of attrition.

### RELATED APPLICATION

This application claims priority to U.S. Provisional Application No. 63/533,694, filed Aug. 20, 2023, which is incorporated herein by reference.

### FIELD OF THE INVENTION

The present invention relates generally to human resource economic management and analysis. More particularly, disclosed herein is an automated infrastructure and method for human capital economic analysis and management through employee life cycle cost determination, return on investment examination, and the creation of the framework for decision making.

### BACKGROUND OF THE INVENTION

Even with extensive education, training, and experience, many human resource leaders cannot clearly articulate employee life cycle costs, the value of employee investment, or the financial impacts of decisions related to such topics. While such information and the decision making deriving therefrom are critical to human resource management and corporate success, human resource leaders often struggle to accumulate and analyze the information and to be successful in educating senior leadership regarding the benefits of acquiring such data and making knowledgeable decisions based thereon.

The difficulties related to identifying employee life cycle costs, the value of employee investment, and the financial impacts of decisions relating thereto have existed for many years. However, in the current time period in the wake of the Covid pandemic, referred to by the present inventor as the Great Realignment, where companies must focus on increased productivity, reduced expenses, and the reevaluation of products, processes, and staffing to maintain or improve competitiveness, those difficulties and the challenges deriving therefrom have become increasingly pronounced.

Indeed, it may reasonably be said that the Covid pandemic changed working patterns forever. As the pandemic waned, there was a war for talent as many companies sought to reopen despite lacking the staffing necessary for returning to pre-Covid operations. This worker shortage led to what was referred to as the Great Resignation where people quit their jobs and jumped to other companies, often at greatly increased salaries based on employer demand. Then, the work force entered a Reevaluation Period with a new trend emerging called Quiet Quitting where people reprioritized their lives. Work became secondary to quality of life and personal interests. Ultimately, though, reality struck. Increased inflation and economic challenges gave rise to the Great Realignment where the needs for increased productivity and expense management were again recognized as being critical to corporate success and survival.

With an awareness of the foregoing, the present inventor appreciated that there is a real need in the field of human resource economic management and analysis for a method and infrastructure for determining employee life cycle costs, for examining return on employee investment, and for establishing a decision-making framework based on that information.

### SUMMARY OF THE INVENTION

The present invention is thus founded on the basic object of providing an automated infrastructure and a method implementing the same for human capital economic analysis, data synthesization, and management through employee life cycle cost determination, return on investment examination, and a decision-making framework.

A related object of the invention is to provide the automated infrastructure required to carry forth human capital economic analysis and management through employee life cycle cost determination, return on investment examination, and the framework necessary to sound decision-making based on the foregoing information.

A more particular object of embodiments of the invention is to provide a model for enabling an understanding of the comprehensive costs involved in employee decision making and for understanding how such costs relate to corporate profit and loss statements.

A further object of practices of the invention is to drive organizational decision making and execution based on employee life cycle costs to increase returns on employee investment.

Another particular object of embodiments of the invention is to provide human resource leaders with the knowledge and tools required for comprehensively evaluating spending over each phase of the employment life cycle thereby enabling educated decision making based on the impact of such decisions on the financial performance of the company.

An additional object of the invention is to provide such a method and automated infrastructure that enables the effective evaluation of past, present, and future decisions.

A related object of the invention is to optimize the role of human resource leaders as strategic contributors to business value and decision making.

These and further objects, advantages, and details of the present invention will become obvious not only to one who reviews the present specification and drawings but also to those who have an opportunity to experience the automated infrastructure and method for implementing the same disclosed herein in operation. However, it will be appreciated that, although the accomplishment of plural of the foregoing objects in a single embodiment of the invention may be possible and indeed preferred, not all embodiments will seek or need to accomplish each and every potential advantage and function. Nonetheless, all such embodiments should be considered within the scope of the present invention.

In carrying forth one or more objects of the invention, one embodiment of the invention can be characterized as an automated computer infrastructure for synthesizing computer data regarding employee life cycle costs for human capital economic analysis and management. The automated computer infrastructure is founded on a computerized framework that is operative to receive and process employee life cycle financial data elements in an automated manner by computer to transform the life cycle financial data elements into actionable synthesized human resource economic analysis. The computerized framework comprises computer data entry and analysis software adapted for receiving individual employee and organizational life cycle financial data elements relating to costs of hire, costs of training & onboarding, and costs of offboarding. The computerized framework is operative automatically to process and transform the individual employee and organizational life cycle financial data elements to yield actionable synthesized human resource economic analysis. In practices of the invention, the computerized framework further comprises computer hardware comprising one or more computer processors, data entry components, and electronic memory for retaining the computer data entry and analysis software and employee life cycle financial data elements to be transformed into actionable synthesized human resource economic analysis.

In certain embodiments, the computerized framework is operative to receive and process employee life cycle financial data elements comprising a number of employee hires for each of plural employee tiers, a number of employee applications for each of the plural employee tiers, a total number of employee applications, and an overall salary of a recruiting department. The computerized framework is further operative to transform those life cycle financial data elements in an automated manner by computer to percentage of recruiter time spent on each of the plural employee tiers and recruiter cost per hire for each of the plural employee tiers. For example, the percentage of recruiter time spent on each of the plural employee tiers can be automatically calculated by the computerized framework based on the number of employee applications for each employee tier divided by the total number of employee applications.

It is also disclosed herein for recruiter cost per hire for each of the plural employee tiers to be automatically calculated by the computerized framework based on dividing the percentage of recruiter time spent on each of the plural employee tiers and multiplying the same by the overall salary of the recruiting department by the number of employee hires for each of the plural employee tiers. According to the invention, recruiter cost per hire can be included within total employee hiring costs.

In manifestations of the automated computer infrastructure, the computerized framework is operative to receive and process employee life cycle financial data elements comprising total department salary for a department spending time on hiring, a percentage of time spent by the department spending time on hiring on each of plural employee tiers, a number of employee applications for each of the plural employee tiers, a total number of employee applications, a number of employee hires for each of the plural employee tiers, a total number of employee hires and to transform those life cycle financial data elements in an automated manner by computer to hiring salary overhead for the department spending time on hiring. For example, the hiring salary overhead for the department spending time on hiring can be automatically calculated by the computerized framework based on the formula:

((total department salary for the department spending time on hiring×percentage of time spent by the department spending time on hiring on a respective employee tier)×(number of employee applications for the respective plural employee tier/total number of employee applications))/total number of employee hires.

Also according to the invention, the computerized framework can be operative to receive and process employee life cycle financial data elements comprising total salary for administrative personnel spending time on hiring and hours spent by the administrative personnel on hiring and to transform those life cycle financial data elements in an automated manner by computer to salary time costs for the administrative personnel spending time on hiring. In instances of the invention, the salary time costs for the administrative personnel spending time on hiring is automatically calculated by the computerized framework based on the formula:

(total salary for administrative personnel spending time on hiring/2080)×hours spent by the administrative personnel on hiring.

The automated computer infrastructure is also disclosed as having the computerized framework operative to receive and process employee life cycle financial data elements comprising an average number of interviews per employee, average interview length in hours, average number of interviewers, and average interviewer salary to transform those life cycle financial data elements in an automated manner by computer into total interview time, hourly cost of interview time, and total cost of interview time. In certain examples, the total interview time is automatically calculated by the computerized framework based on formula: ((average number of interviews per employee×average interview length in hours)×average number of interviewers)/60. The total cost of interview time can be automatically calculated by the computerized framework based on the formula: Total cost of interview time×(average interviewer salary/2080).

Embodiments of the automated computer infrastructure are disclosed wherein the computerized framework is operative to receive and process employee life cycle financial data elements comprising total contract costs for each of plural employee tiers and number of employee hires within each of the plural employee tiers and to transform those life cycle financial data elements in an automated manner by computer into contract costs per employee. For example, pursuant to practices of the invention, the contract costs per employee is automatically calculated by the computerized framework based on dividing the total contract costs for each of the plural employee tiers by number of employee hires within each of the plural employee tiers.

Also according to the invention, the computerized framework is operative to receive and process employee life cycle financial data elements comprising average employee trainer salary, number of working days in a year, and average number of days of employee training and to transform those life cycle financial data elements in an automated manner by computer into cost of training per employee. For instance, cost of training per employee is automatically calculated by the computerized framework in embodiments of the invention based on dividing the average employee trainer salary by the number of working days in a year and multiplying the result by the average number of days of employee training.

Further still, it is disclosed that the computerized framework is operative according to the invention to receive and process employee life cycle financial data elements comprising an average salary of mentors, number of working days in a year, and average number of days of mentorship and to transform those life cycle financial data elements in an automated manner by computer into a salary cost of mentoring. The salary cost of mentoring can, for example, be automatically calculated by the computerized framework based on dividing the average salary of mentors by the number of working days in a year and multiplying the result by the average number of days of mentorship.

Embodiments of the automated computer infrastructure are taught herein where the computerized framework is operative to receive and process employee life cycle financial data elements comprising an average salary of employees involved in knowledge retention on employee departure and total hours spent by employees involved in knowledge retention on employee departure and to transform those life cycle financial data elements in an automated manner by computer into a knowledge retention expense. More particularly, the knowledge retention expense can be automatically calculated by the computerized framework based on dividing the average salary of employees involved in knowledge retention on employee departure by 2,080 and multiplying the result by the total hours spent by employees involved in knowledge retention on employee departure.

In practices of the invention, the computerized framework is operative to receive and process employee life cycle financial data elements comprising an average salary of employees involved in exit interviews and administrative tasks on employee departure and total hours spent by employees involved in exit interviews and administrative tasks on employee departure and to transform those life cycle financial data elements in an automated manner by computer into an offboarding expense. This is carried out in one example by dividing the average salary of employees involved in exit interviews and administrative tasks on employee departure by 2,080 and multiplying the result by the total hours spent by employees involved in exit interviews and administrative tasks on employee departure.

The computerized framework can also be operative to receive and process employee life cycle financial data elements comprising average salary for an employee tier, productivity value in relation to employee salary, notice period in weeks, percentage productivity lost following notice of leaving, average time in days to backfill employee position, productivity lost during employee path to proficiency, and time to reach proficiency in months and to transform those life cycle financial data elements in an automated manner by computer into loss of productivity following notice of departure, loss of productivity during backfill, and loss of productivity during path to proficiency. The loss of productivity following notice can, for example, be automatically calculated by the computerized framework based on dividing the average salary for an employee tier by 2,080, multiplying the result by the percentage productivity lost following notice of leaving, and multiplying that result by productivity value in relation to employee salary. Meanwhile, the loss of productivity during backfill can be automatically calculated by the computerized framework based on multiplying average time in days to backfill employee position by the result of multiplying productivity value in relation to employee salary by average salary for the employee tier, and the loss of productivity during path to proficiency can be automatically calculated by the computerized framework based on multiplying productivity value in relation to employee salary by productivity value during path to proficiency and multiplying the result by time to reach proficiency.

Also as disclosed herein, the computerized framework is operative to receive and process employee life cycle financial data elements comprising a number of employee hires for each of plural employee tiers, a number of employee departures for each of plural employee tiers, costs of hire, costs of training & onboarding, costs of offboarding, productivity losses, and costs of backfill and to transform those life cycle financial data elements in an automated manner by computer to costs of attrition. The employee life cycle financial data elements can be separated by employee tier, and the computerized framework can be operative to transform the life cycle financial data elements into costs of attrition by employment tier and in total. Further still, the computerized framework can be operative to determine and display cost reduction potentials due to specified reductions in employee attrition.

One will appreciate that the foregoing discussion broadly outlines certain goals and features of non-limiting embodiments of the invention to enable a better understanding of the detailed description that follows and to instill a better appreciation of the inventor's contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

In the accompanying drawing figures:

FIG. 1 is a graphic user interface of a home screen of a computer infrastructure for determining employee life cycle costs with return on investment calculation and decision making framework according to the present invention;

FIG. 2 is a schematic depiction of a potential employee life cycle;

FIG. 3 is a graphic user interface of costs involved in a typical employee life cycle;

FIGS. 4A through 4I are graphic user interfaces depicting points of data entry in a computer infrastructure for determining employee life cycle costs with return on investment calculation and decision making framework according to the present invention;

FIGS. 5A through 5I are user interfaces depicting points of data entry and automated analytical output in a computer infrastructure pursuant to the present invention;

FIG. 6 is a user interface depicting individual and total costs over a typical employee life cycle as automatically determined based on entered data;

FIG. 7 is a user interface depicting individual hiring costs as automatically determined based on entered data;

FIG. 8 is a user interface depicting total hiring costs as automatically determined based on entered data;

FIG. 9 is a user interface depicting total employee backfilling costs as automatically determined based on entered data;

FIG. 10 is a user interface depicting individual costs involved in hiring, training, and offboarding individual employees as automatically determined based on entered data;

FIG. 11 is a user interface depicting individual costs involved in backfilling employee positions as automatically determined based on entered data;

FIG. 12 is a user interface depicting total organizational hiring and backfilling costs as automatically determined based on entered data; and

FIG. 13 is a user interface depicting organizational savings based on reduced employee attrition rates as automatically determined based on entered data.

### DETAILED DESCRIPTION OF PREFERRED EMBODIMENTS

The present invention for an automated infrastructure and method for human capital economic analysis and management through employee life cycle cost determination, return on investment examination, and decision-making framework could pursue widely varied embodiments. However, to ensure that one skilled in the art will be able to understand and, in appropriate cases, practice the invention, certain preferred embodiments of the broader invention revealed herein are described below and shown in the accompanying drawing figures. These embodiments are intended to be illustrative but not limiting.

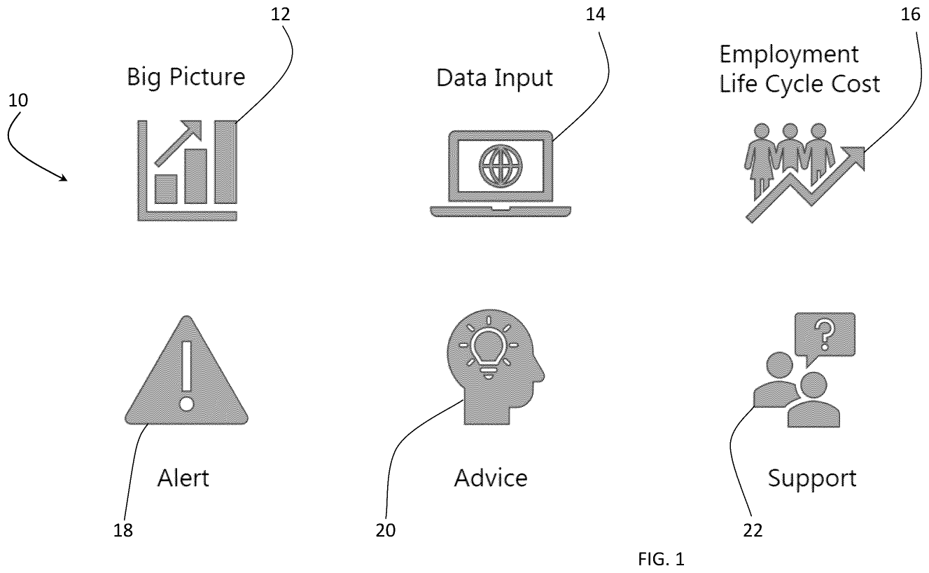

Turning more particularly to the drawings, embodiments the present invention for an automated infrastructure and method for human capital economic analysis, data transformation and synthesizing, and management through employee life cycle cost determination, return on investment examination, and the creation of the framework for decision making can be further understood with referenced to FIGS. 1 through 13, the textual, numeric, and other information set forth therein being incorporated into this specification by reference. As disclosed herein, the inventive method and automated infrastructure provide the informational tools and thinking required for educated decision-making for talent strategy for human resource and executive officers. The method and infrastructure disclosed herein enable a comprehensive understanding of organizational costs of employees in relation to company profits and losses.

A home graphic user interface for an automated computer infrastructure according to the present invention is indicated generally at 10 in FIG. 1. As referred to herein, the automated computer infrastructure 10 can be considered to include computer hardware, such as one or more computer processors, data entry components, electronic memory, acting in combination with dedicated computer software adapted to carry out the data analysis, transformation, and synthesis shown and described herein. In FIG. 1, icons are provided that are representative of the foregoing and that enable data entry, control, and human capital economic analysis and management through the automated computer infrastructure 10. More particularly, the automated infrastructure 10 provides a data input icon 14 as a schematic representation of the computer hardware, including one or more computer processors, data entry components, and electronic memory and computer software retained in electronic memory, operative through the computer processor or processors, and controlled by the data entry components. The computer hardware may be embodied as a single computing device or as a plurality of computing devices operating in cooperation.

The data input icon 14 is operative hereunder to enable the input of employee and organizational data as shown and described further hereinbelow. Actuation of what may be referred to as a big picture icon 12 using the computer hardware and software disclosed herein enables a viewing of automated organizational analysis based on data input by use of the data input icon 14, and individual and overall employee life cycle costs as automatically determined by the automated computer infrastructure 10 can be displayed for review by actuating an employment life cycle cost icon 16. Still further, automatically provided, generalized and particularized alerts, advice, and support can be obtained by actuation of alert, advice, and support icons 18, 20, and 22.

Making use of the automated computer infrastructure 10, human resource personnel are thus provided with the computer-automated tools and information analyzed and transformed by those tools needed to communicate such organizational costs and benefits while leaders are given a framework capable of driving organizational execution to deliver increased return on investment. Human resource leaders are empowered with the knowledge and tools necessary to evaluate spending for each phase in the employment life cycle to make educated decisions based on their determined impact to the financial performance of the company, such as by review of automatically calculated organizational and individual employee data displayed by actuation of one or more of the big picture, employment life cycle cost, alert, advice, and support icons 12, 16, 18, 20, and 22.

Past, present, and future decisions can be evaluated based on comprehensive employee life cycle data as processed, analyzed, synthesized, and transformed by the automated infrastructure 10 and displayed by actuation of the employment life cycle cost icon 16. As shown and described further herein, the display of employment life cycle cost data as triggered by actuation of icon 16 enables returns on a company's investment in employees, employee training, and employee retention to be quantified. Organizations can thus be prepared for sustainable success, and the roles of human resource leaders are optimized as strategic contributors driving business value and decision making. Data insight provided by the present automated computer infrastructure 10 and method enables a shift from reactionary and remedial actions to proactive management and a shift from intangible, aspirational human resource goals to quantifiable, specific business impacts.

While the automated computer infrastructure 10 disclosed herein provides concrete analysis and action based on entered and processed data, it will be appreciated that practicing the inventive system and method within a given organization would typically begin with the foundational step of establishing theoretical agreement with and within the organization, identifying key participants, and gaining corporate commitment to the implementation. Then, an education step can be initiated where key staff members are engaged, the inventive concepts are taught, and individual comments and commitments are gained. With these steps accomplished, implementation can be carried forth by sharing insights obtained through the automated infrastructure 10 with key leaders. Items with greatest impact aligned with company strategy can be identified based on automated calculation and analysis by the automated infrastructure 10.

Moreover, return on investment is projected, implemented, and measured in actual impact through automated computer analysis by the automated infrastructure 10. Iterations of such return on investment calculations and proactive and responsive measures based on actual data input 14 and employment life cycle costs 16 can be performed.

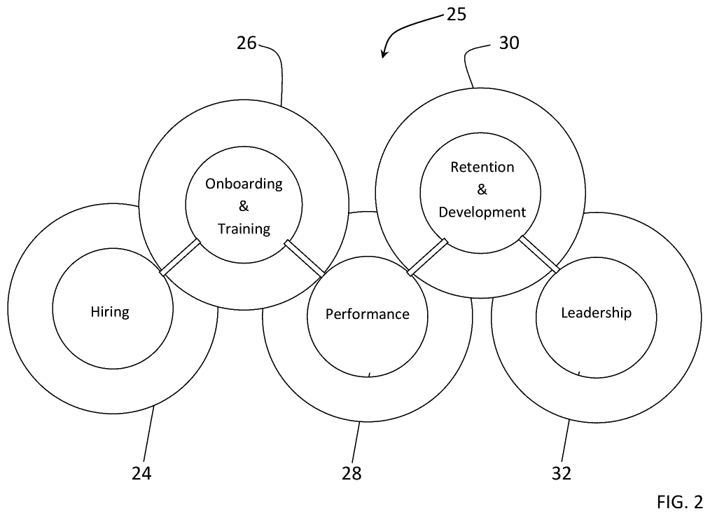

A typical employee life cycle 25 is schematically shown in FIG. 2. There, the interrelated and interdependent stages of the employee life cycle 25 can be seen to include the hiring process 24, the onboarding and training processes 26, job performance 28, retention and development practices 30, and leadership development 32. As disclosed herein, the tools provided by the present method and automated infrastructure 10 can be employed to understand how each stage 24, 26, 28, 30, and 32 in the employee life cycle 25 impacts and interacts with each prior and subsequent stage 24, 26, 28, 30, and 32.

As is proven out by the automated and particularized analysis performed by the present automated infrastructure 10, the ability to hire, train, and retain staff efficiently results in competitive advantage and cost benefits. Both are critical to corporate survival and success. Moreover, as proven out by the automated infrastructure 10, retaining and developing the highest performing employees contributes to a successful strategy for consistent high performance. Moreover, developing high-performing employees into leadership positions and roles in the leadership development phase 32 brings the corporate strategy devised based on the analysis and information provided by the automated infrastructure 10 to life.

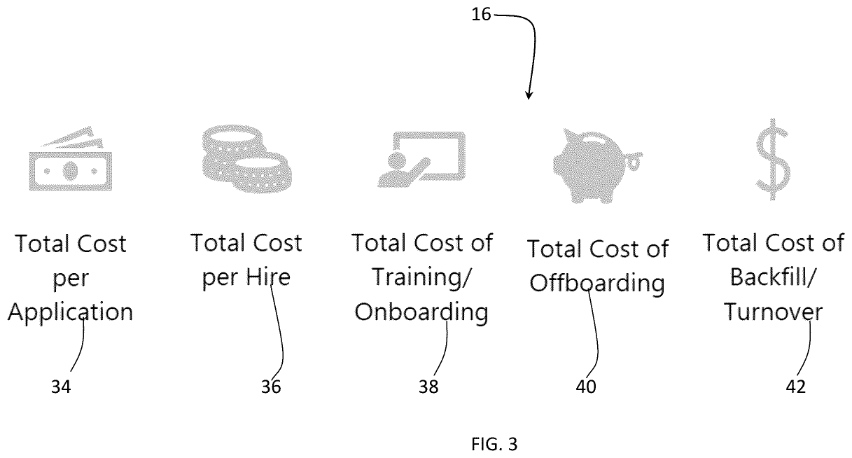

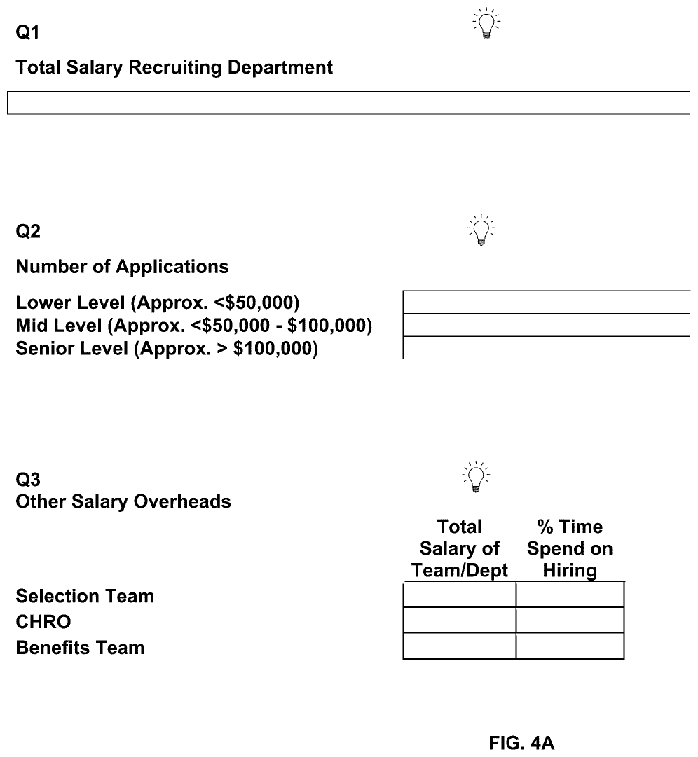

As disclosed herein, the automated infrastructure 10 for trapping and evaluating all employee life cycle costs and understanding how the factors contributing to life cycle costs interrelate is carried forth by computer processing, synthesis, and transformation of employee and organizational data entered and retained in electronic memory for useful further analysis by computer processor. Notable aspects that are to be calculated by the automated infrastructure 10 based on data entered and electronically retained in memory include those shown in the interactive employment life cycle cost user interface 16 shown apart in FIG. 3. There, the infrastructure 10 is shown to enable a determination of the total cost per employee application 34, the total cost per employee hire 36, and the total cost of employee training/onboarding 38 as well as the total cost of employee offboarding 40 and the total cost of employee backfill/turnover 42 when applicable. As described further herein, those costs can be provided organization wide and particularized for multiple employment tiers.

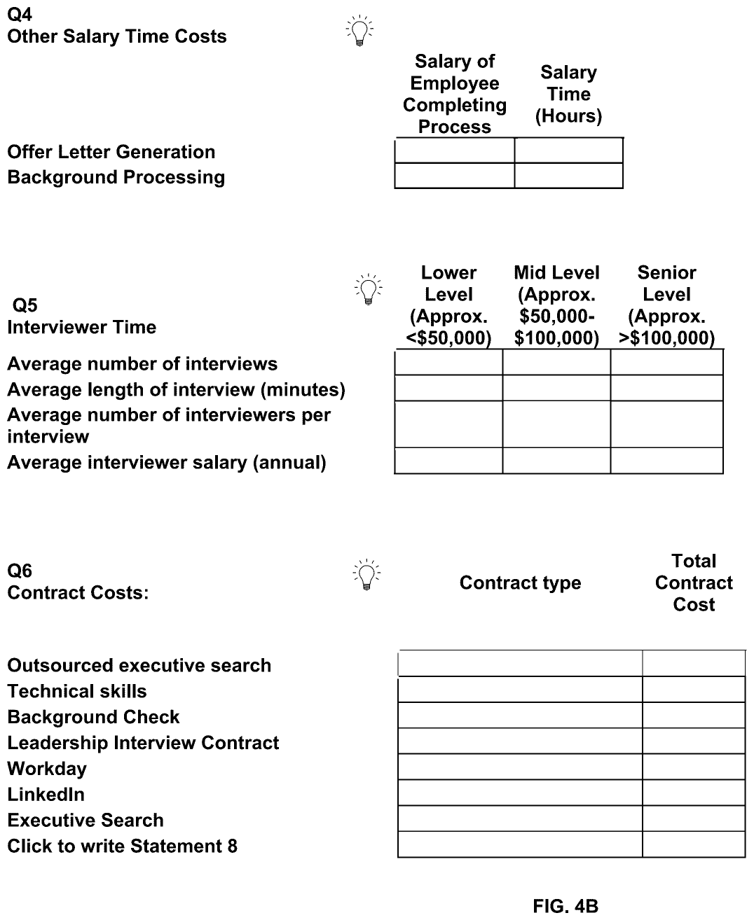

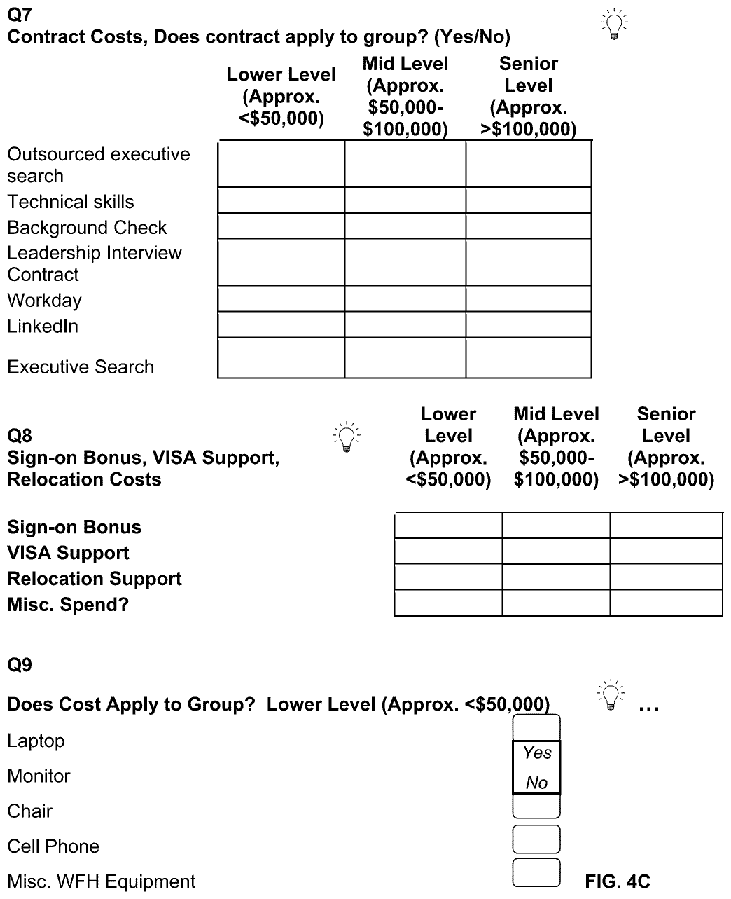

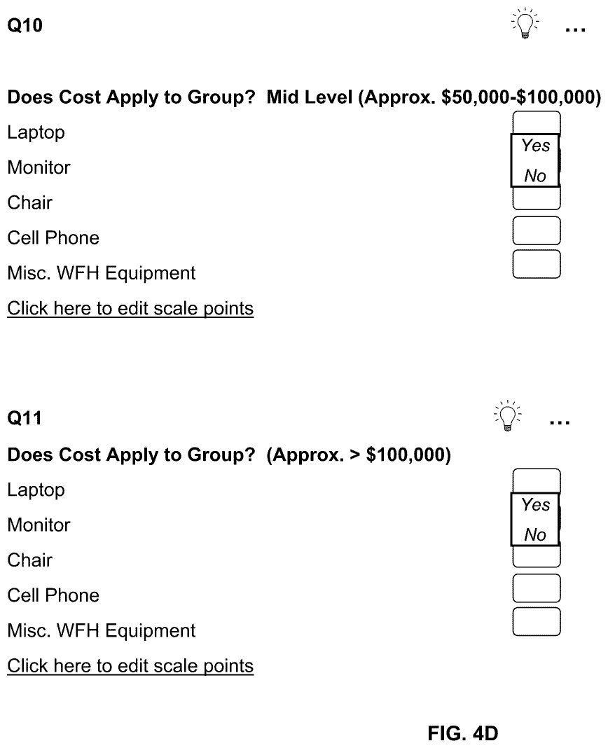

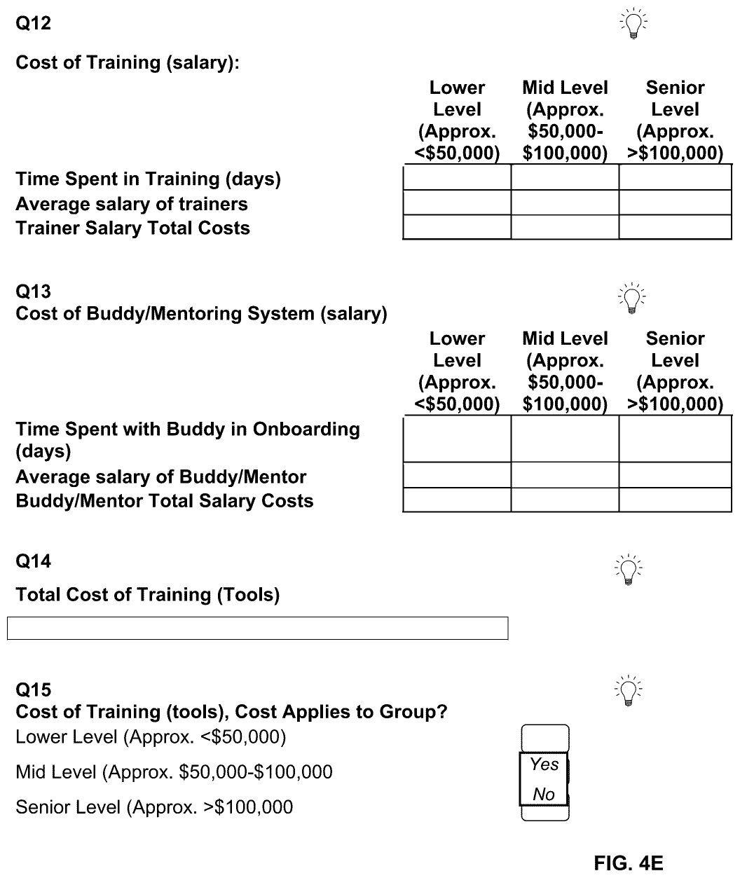

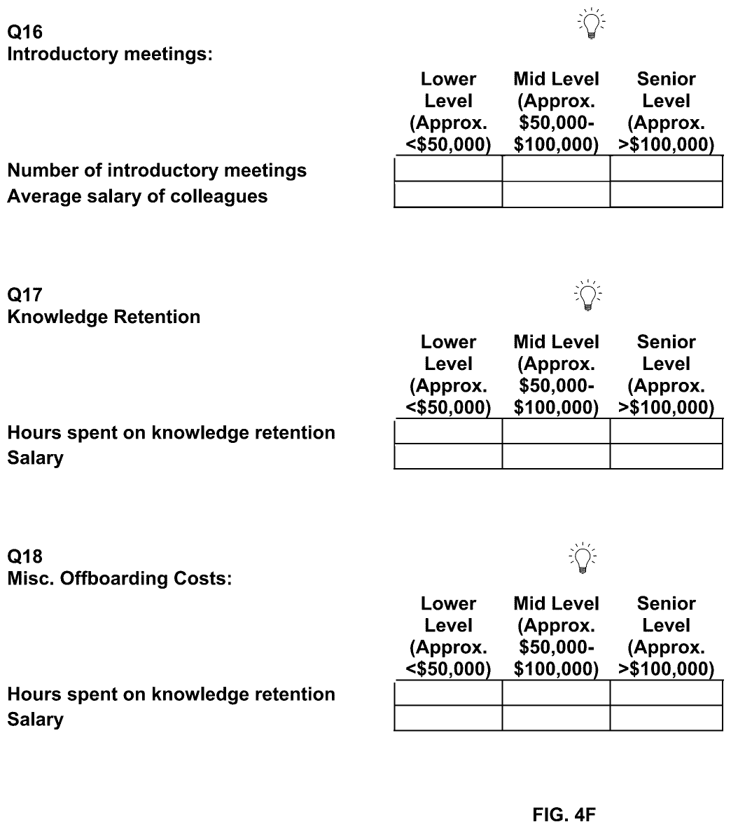

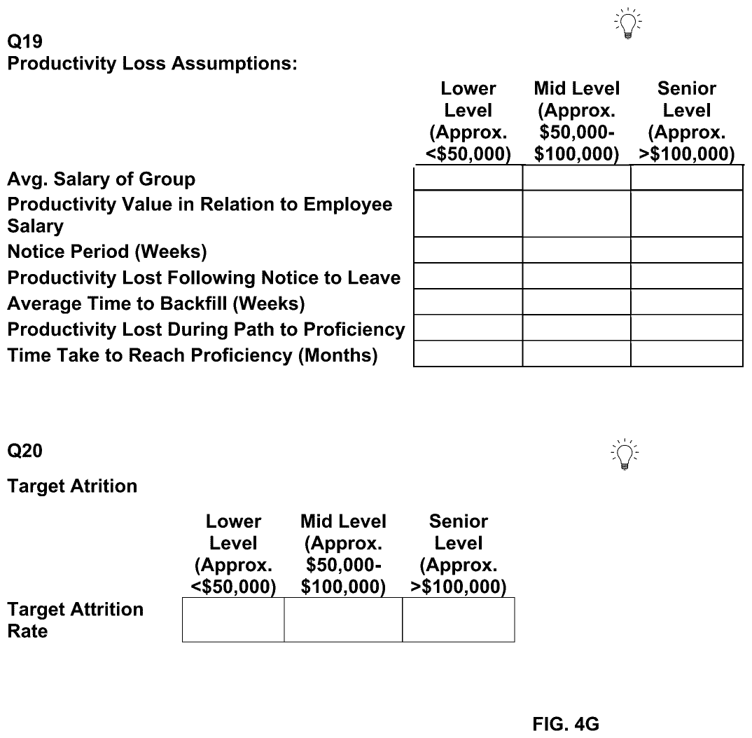

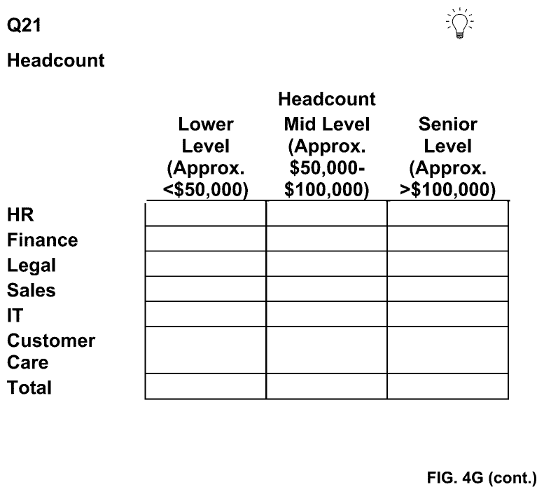

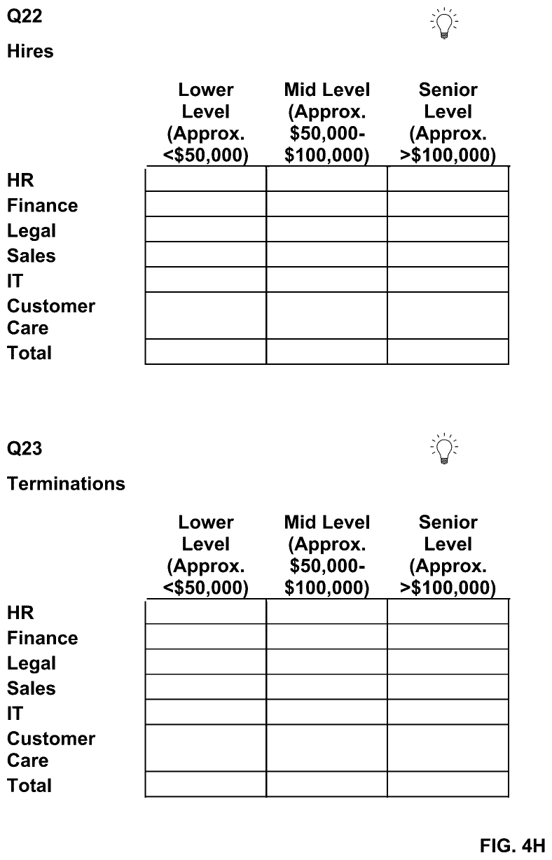

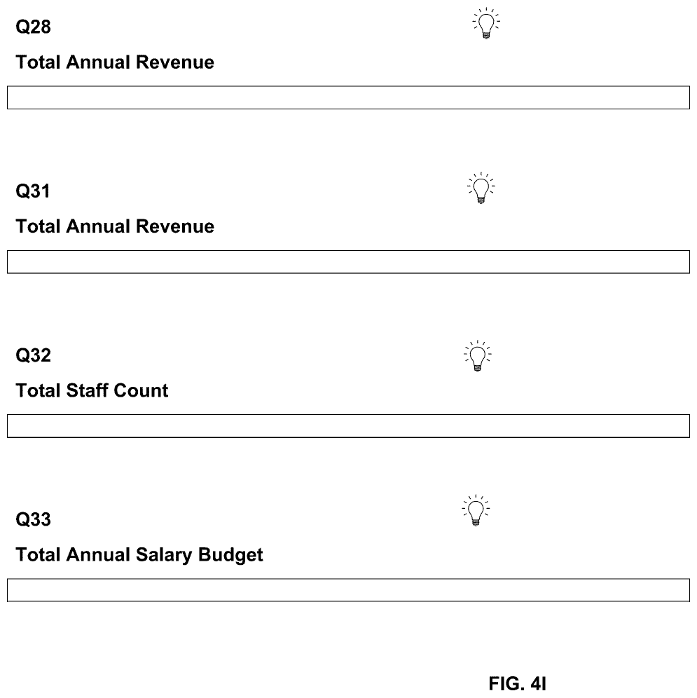

Graphic user interfaces enabling the entry of the requisite data for analysis can be perceived in FIGS. 4A through 4I. As shown, employee and organizational data can be entered into the memory of the automated infrastructure 10 for processing and analysis using the dedicated data entry boxes in a sequential or other manner. As in FIG. 4A, one can enter, for instance, the total salary of the recruiting department (Q1) as well as the total number of applications processed for multiple employment tiers, such as lower level, mid-level, and senior level employees, separately (Q2) and other salary overheads for individual teams and departments (Q3).

According to practices of the invention, application costs to be entered into the automated infrastructure 10 can include, but are not limited to, annual or otherwise fixed costs, candidate relationship management systems, applicant tracking systems, annual contracts as with Indeed, LinkedIn, and other annual contracts, variable costs for employee attraction as in the form of advertisements, job boards, job fairs, applicant contacts, administrative costs, including text, emails, phone calls, recruiting, staff and/or recruiter time, posting review time, and additional costs.

In many instances herein, employees are divided into employment tiers based on annual income. For example, to segment the costs of hire, training, development, and attrition beyond global totals, employees can be divided into three tiers comprising lower level, mid-level, and senior or upper level employees. In the present example, the lower level employee tier is characterized as those earning less than $50,000 per year while the senior or upper level employee tier is characterized as those earning more than $100,000 per year and the mid-level employee tier is presumed to be that between the lower and upper level tiers, specifically those earning between $50,000 and $100,000. Of course, these tier numbers are mere examples for the purposes of the present disclosure. Different tier levels may be appropriate for different organizations and for different time periods.

As in FIG. 4B, other salary time costs (Q4), including, for instance, offer letter generation and background processing, can be entered as well as interviewer time (Q5), including average number of interviews and interviewers, average interview length, and average interviewer salary, based on employment tier, and contract costs (Q6) based on contract type and in total, including outsourced executive search costs, technical skills evaluations, background checks, leadership interview contracts, proprietary employee search subscriptions, in-house executive search expenses, and Statement 8 conceptual framework for financial reporting expenses, can be entered. As shown in FIG. 4C, corresponding types of contract costs can be entered by employment tier (Q7). As is also shown in FIGS. 4C and 4D, one can enter employee acquisition costs (Q8) by employment tier relating to sign-on bonuses, VISA support, and relocation and other costs, and one can input individual employee equipment costs (Q9, Q10, and Q11), such as for laptops, computer monitors, chairs, mobile telephones, and miscellaneous equipment, based on employment tier.

As FIG. 4E illustrates, one can enter time spent in training and trainer salaries based on employment tier (Q12) to enable a calculation of salary training costs, and one can input time spent with mentor/buddy and average mentor/buddy salary based on employment tier (Q13) to enable a calculation of salary mentoring costs based on employment tier. Further still, one can enter total training costs based on tools overall (Q14) and based on employment tier (Q15).

Looking to FIG. 4F, one can enter for individual employment tiers a number of introductory meetings and the salaries of colleagues involved therein (Q16) to enable a calculation of introductory meeting costs, hours spent on knowledge retention and the average salaries of the persons involved (Q17) to enable a calculation of knowledge retention costs, and hours spent on miscellaneous offboarding and the average salaries of the persons involved (Q18) to enable a calculation of miscellaneous offboarding costs.

As in FIG. 4G, one can enter productivity loss assumptions (Q19) to enable a calculation of assumed productivity losses, such as average salaries, productivity value in relation to salary, notice period, productivity presumed lost following notice to leave, average employee backfill time, productivity presumed to be lost during path to proficiency, and time required to reach proficiency. As FIG. 4G also shows, one can enter target attrition rates (Q20) individually based on employment tier and headcount (Q21) based on department and employment tier.

Looking to FIG. 4H, departmental hiring and termination costs (Q22 & Q23), including human resources, finance, legal, sales, information technology, and customer care, can be entered based on employment tier. Hiring costs will preferably include all costs associated with generating an application plus the cost of background checks and other identifiable hiring costs, including the costs of interviewing, assessing skills, and completing the selection process. Yet further, as FIG. 4I depicts, one can enter total annual revenue (Q28 & Q31), total staff count (Q32), and total annual budget for employee salaries (Q33).

It will be understood that further or lesser data may be applicable or available in particular instances. It will be clear, however, that any application of the automated infrastructure 10 and method enable a robust analysis of organization wide and particularized information relating to individual departments, separate employment tiers, the organization in general, and other aspects. The automated processing, data conversion, and analysis provided by the automated infrastructure 10 are critical to understanding previous human resource characteristics and potential improvements thereon within a given organization. The automated infrastructure 10 and method provide for the verifiable understanding needed for making and supporting well-founded human resource decisions and corporate planning.

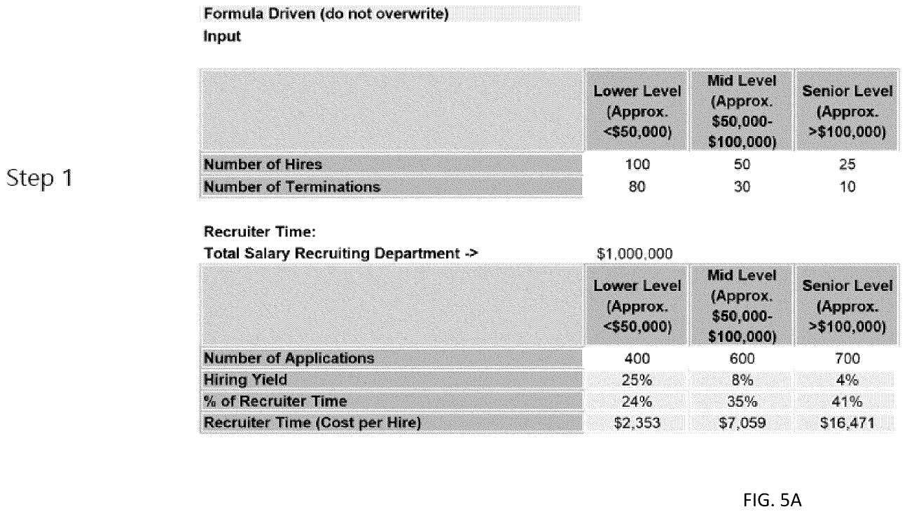

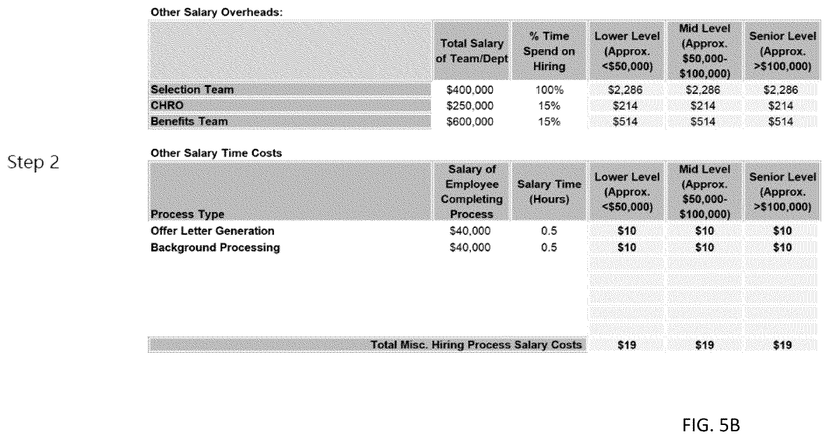

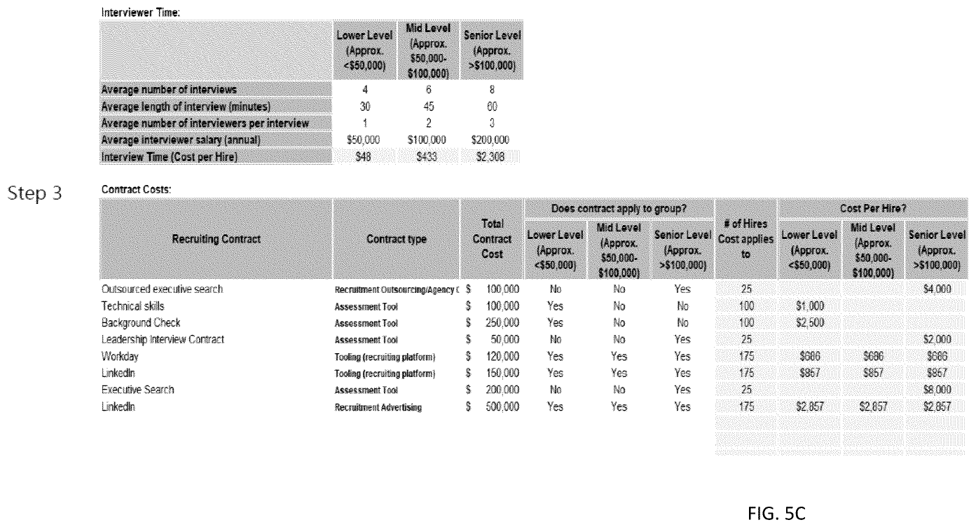

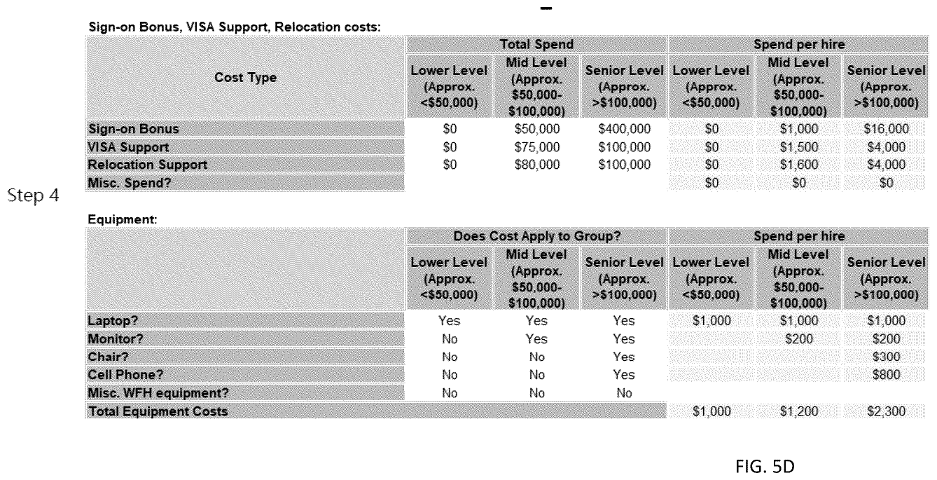

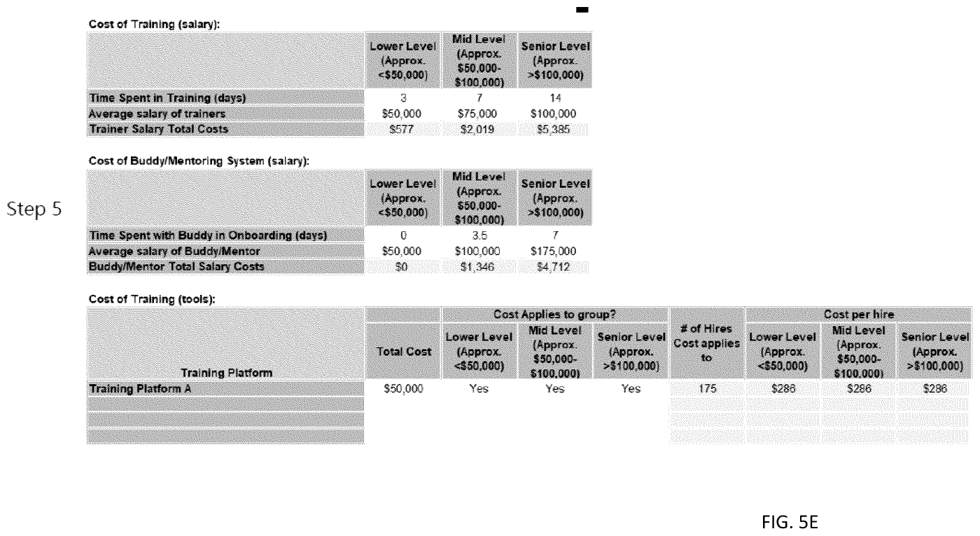

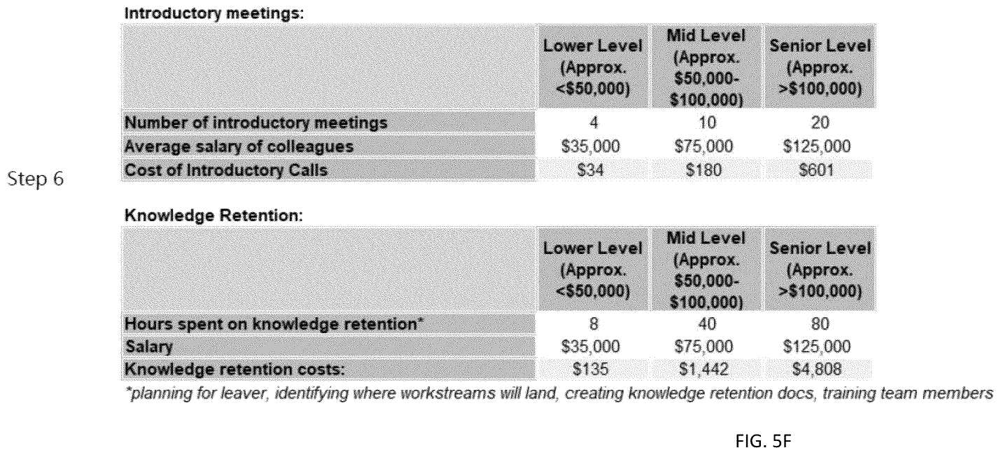

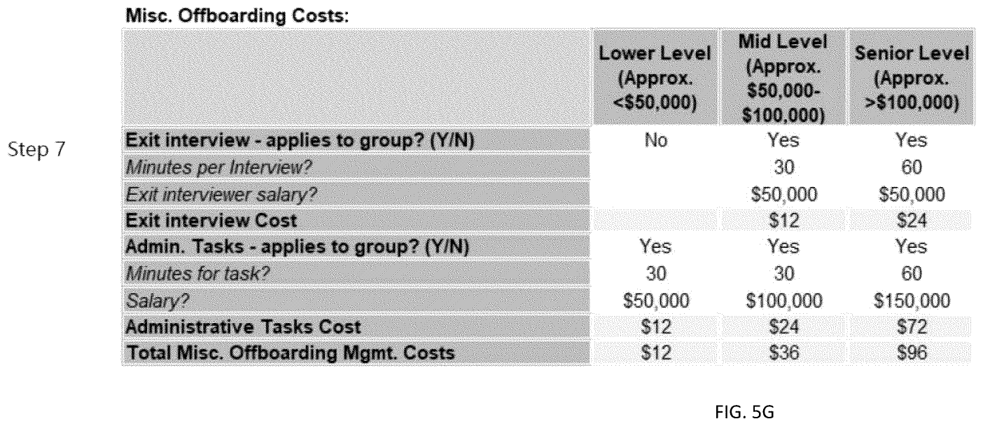

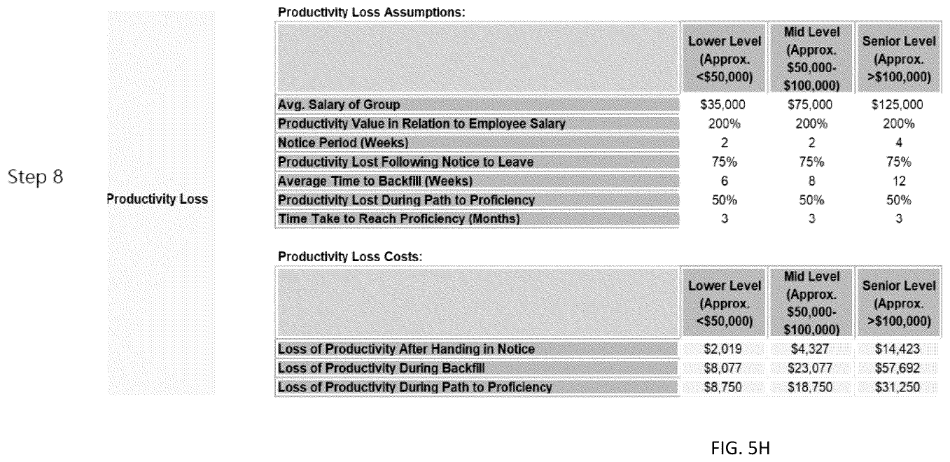

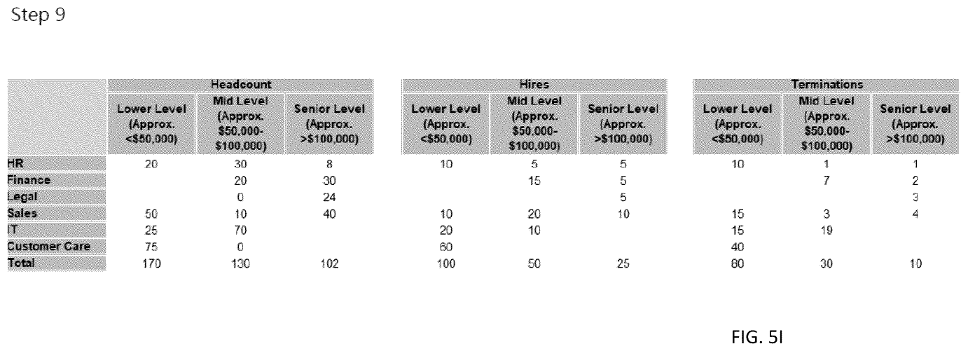

Application of the automated infrastructure 10 to real-world data can be further understood with reference to FIGS. 5A through 13. There, processing of company data electronically recorded, such as through the graphic user interfaces of FIGS. 4A through 4I, can be understood. As previously discussed, employees can be divided into the three tiers to enable a segmentation of the costs of hiring, training, and attrition beyond organization-wide information. The tiers can comprise, for example, lower level, mid-level, and senior or upper level tiers. In the non-limiting examples provided herein, the lower level employee tier is characterized as those earning less than $50,000 per year while the senior or upper level employee tier is characterized as those earning more than $100,000 per year and the mid-level employee tier is therebetween, specifically between $50,000 and $100,000. As is further shown and described herein, headcount, number of hires, and number of terminations can be electronically recorded as in FIGS. 4G, 4H, 5A, and 5I.

As in FIG. 5A, Hiring Yield can be automatically calculated by dividing the number of hires by the number of applications. Percentage of recruiter time spent on each employee tier is calculated based on the number of applications for the respective tier divided by the total number of applications. Recruiter Cost per Hire is then calculated by the automated infrastructure 10 based on the overall salary of the recruiting department, the number of hires, and the percentage of time spent on the employment tier entered as described above with the formula being:

(percentage of recruiter time×total recruiting department salary)/number of hires

The total salary of the recruiting department should include the total cost of all recruiters, recruitment operations employees, recruiting managers, and directors, including bonuses and employment costs and taxes. By further reference to FIG. 5A, for instance, one can perceive the total cost per hire based on recruiter time for a given organization as being $2,353 for lower level employees, $7,059 for mid-level employees, and $16,471 for senior or upper level employees where there were 100, 50, and 25 hires for the respective employee tiers with hiring yields of 25%, 8%, and 4% respectively and percentages of recruiter time of 24%, 35%, and 41% respectively.

Turning to FIG. 5B, Other Salary Overheads, specifically salary costs other than recruiting that are associated with hiring an employee at each tier can be calculated by the automated infrastructure 10 by taking the total salary of the respective department and multiplying it by the percentage of time spent on hiring. Then, this is broken down to estimate the percentage of this total cost that is accounted for by each employee tier pursuant to the following formula:

((Total dept. salary×% time spent on hiring)×% of applications at employee tier)/number of hires

The required input for the foregoing calculation comprises total department/team salary and the percentage of time spent hiring. Any team or special individual roles that contribute to hiring should be included in the input with it being recognized that there are typically several teams that support hiring outside of recruitment personnel, including benefits, selections, chief human resources officer (CHRO), human resource business partners, and information technology personnel.

Continuing to refer to FIG. 5B, Other Salary Time Costs, which measures the costs of administrative tasks associated with hiring, is calculated by converting the annual salary of the employee involved in the respective administrative task into hourly pay and then multiplying that by the number of hours to complete the administrative tasks. The following formula is used:

$$( Total salary / 2080 ) \times Salary hours$$

With reference to FIG. 5C, the automated infrastructure 10 also automatically calculates the expense of Interviewer Time separately from any recruiter time spent in interviewing. To accomplish this, the infrastructure 10 requires input of the average number of interviews, the average interview length, the average number of interviewers, and the average interviewer salary as in FIG. 4B. Interviewer Time can then be calculated according to the following series of formulas, first calculating Total Interview Time then the Hourly Cost of that time, and then the Total Cost of Interviewer Time:

$$Total interview time ( hours ) = ( ( Number of interviews \times avg . length of interview ) \times avg . number of interviewers ) / 60$$

$$Hourly Cost = Average interviewer salary / working hours in year$$

$$Total Cost = Total interview time ( hours ) \times Hourly Cost$$

FIG. 5C also depicts the method by which the automated infrastructure 10 calculates Contract Costs, the costs of assessment tools, recruitment outsourcing, and tooling with total contract costs being divided by the number of employees to which the costs apply. To enable this calculation, a recruiting contract name or description may be entered as well as the type as an assessment tool, recruitment outsourcing, or tooling, the total contract cost, and the employment tier or tiers to which the cost applies. Based on this information, the automated infrastructure 10 calculates Contract Costs according to the following formula:

total cost/number of hires within the applicable employee tiers

As in FIG. 5D, Sign-on Bonus, VISA Support, and Relocation Costs are automatically calculated in total and per hire by the automated infrastructure 10 with the total spending on such mobility and sign-on bonuses broken out by employment tier. This is calculated according to the following formula:

Total spend/number of hires

Spending per hire on Equipment is calculated as is also shown in FIG. 5D based on user inputs as to which equipment expenses apply to which employment tier and the cost of the equipment involved. Based on this data, the automated infrastructure 10 calculates the spending on each hire at each employment tier applying the following formula:

Total spend on employment tier/number of hires in employment tier

The automated infrastructure 10 also automatically calculates onboarding costs by employment tier. For instance, as shown in FIG. 5E, with Time Spent in Training in days for new employees, including standardized company training and role specific/skills-based training, entered together with the average trainer salary, including any salary differences based on position or employment tier, the following formula is employed to calculate the Cost of Training in salary:

$$( Average Trainer Salary / Working days in a year ) \times Number of days in training$$

As FIG. 5E also shows, the automated infrastructure 10 additionally calculates the salary Cost of any Buddy/Mentoring System based on the entry of Days in Mentorship and the average salary of mentors for each employment tier as in FIG. 4E based on the following formula:

$$( Average Salary of mentor / Working days in a year ) \times Number of working days in mentorship program$$

Further shown in FIG. 5E based on information entered in FIG. 4E is the calculation of the Cost of Training Tools for each employment tier based on the formula:

### Total Training Tool Cost/Number of Hires Trained

As shown in FIG. 5F, onboarding costs further include Introductory Meetings, which comprises the salary costs associated with introductory meetings, as are common with present employees spending a given amount of time, such as 30 minutes, with new hires. To calculate Introductory Meeting salary cost, the typical salary of personnel involved in such meetings by employment tier is entered as in FIG. 4F, and the calculation is according to the following formula:

Hourly salary of colleagues×total hours spent in meetings

Offboarding presents its own costs to be calculated by the automated infrastructure 10 as shown, for instance, in FIGS. 5F and 5G. In FIG. 5F, for example, Knowledge Retention expenses are calculated by employment tier with the entry of the hours spent on knowledge retention, specifically the approximate number of hours spent on planning for the leaving employee, and the average salary of employees spent completing knowledge retention work, such as the departing employee's colleagues and manager, as in FIG. 4F. This represents the salary time that is spent planning for the employee's leaving, identifying where workstreams will land, creating knowledge retention documents, and training team members to cover the work of the departing employee. With such information entered, the computer infrastructure 10 automatically calculates Knowledge Retention expense based on the following formula:

Average hourly salary of employees involved×total hours spent on knowledge retention

Further still, FIG. 5G shows the data involved in the calculation of Miscellaneous Offboarding Costs, such as exit interviews and administrative tasks. These calculations require data input as to whether exit interviews apply based on employment tier, the typical time in hours or portions thereof, and the exit interviewer salary. With that data entered, the computer infrastructure 10 calculates Miscellaneous Offboarding Costs based on the following formula:

$$Hourly salary of interviewer / administrative personnel \times Length of interview / administrative task ( in hours or fractions thereof )$$

Employee departures also involve productivity losses, which are calculated by the automated infrastructure 10 as in FIG. 5H based on the entry of average salary for the employee tier, productivity value in relation to employee salary, notice period in weeks, productivity lost following notice of leaving, average time in weeks to backfill the employee position, productivity lost during employee path to proficiency, and time to reach proficiency in months. Productivity value in relation to employee salary is the measure of productivity as a percentage of the employee's salary. While this varies by industry and nature of work, it is generally held that each employee should provide double their salary in productivity value to the company. Therefore, 200% is the default input in the computer infrastructure 10, but other values can be entered. Regarding productivity lost following notice to leave, it is recognized that, following resignation, an employee's focus will typically shift to handing over work with very little by way of core duties thereafter being completed. The default input in the automated infrastructure 10 is 75% of productivity lost, but other values can be entered. With respect to productivity lost during path to proficiency, the default input is 50% with other values being selectively entered since productivity limitations while gaining proficiency vary based on, for example, the nature of the work involved. With regard to time to reach full proficiency, which is measured in months and defaulted at 3 months in the automated infrastructure 10, it too will vary depending on the nature of the employee role. Other values can be entered. In view of the foregoing, loss of productivity after giving notice is calculated according to the following formula:

(Salary time after handing in notice x % of productivity lost)×Productivity value relative to salary

Loss of productivity during backfill, which is the productivity lost as a position remains vacant, is calculated as follows:

Time to backfill in days×(productivity value×employee salary)

Loss of productivity during path to proficiency is calculated according to the following formula:

(Productivity Value x % productivity during training)×length of training

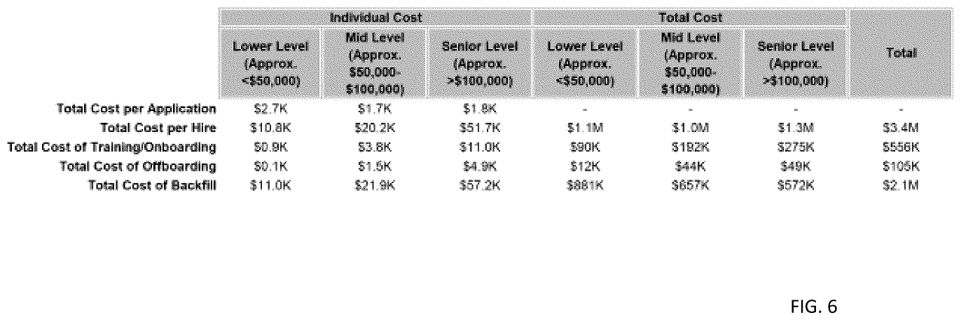

As is illustrated in FIG. 6 and with additional reference to FIG. 3, employing the data and formulas set forth hereinabove, the automated infrastructure 10 is capable of automatically calculating and displaying total cost per employee application 34, total cost per employee hire 36, total cost of training & onboarding 38, total cost of offboarding 40, and total cost of backfill & turnover 42. The foregoing is automatically provided with respect to each employee tier for individual employees and for the organization as a whole.

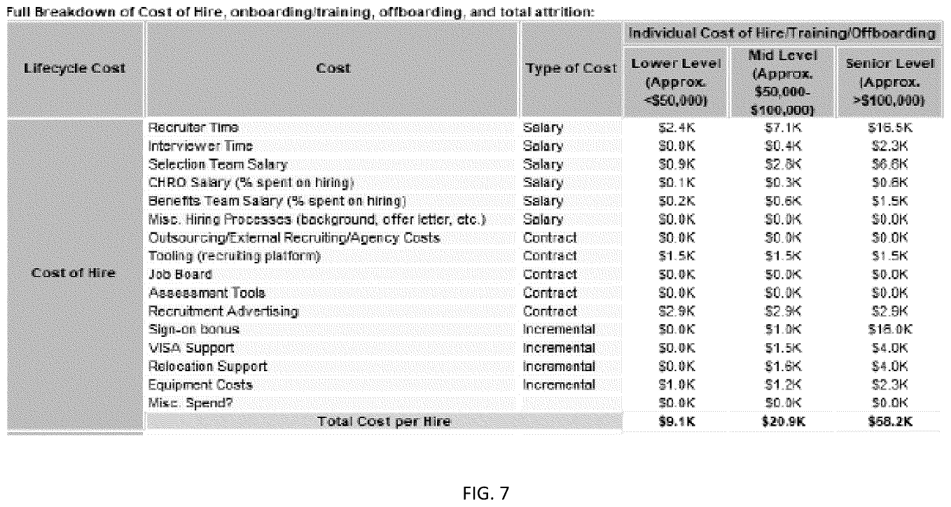

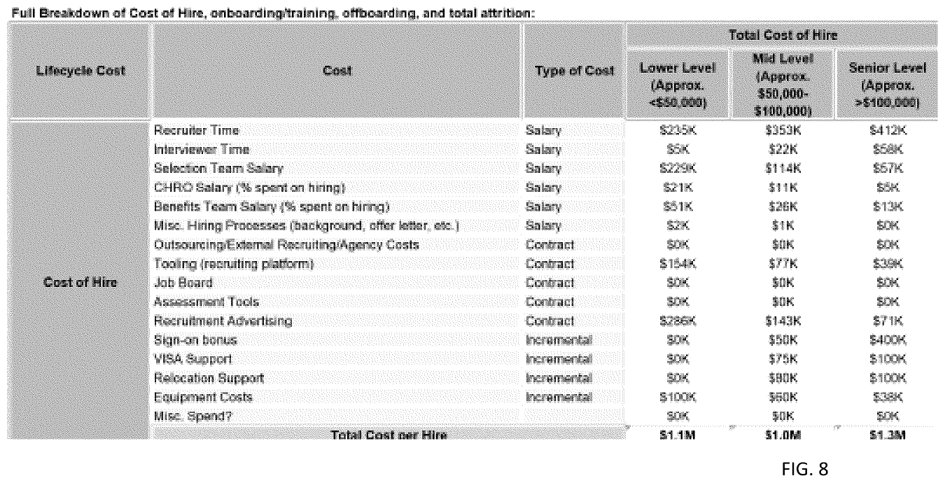

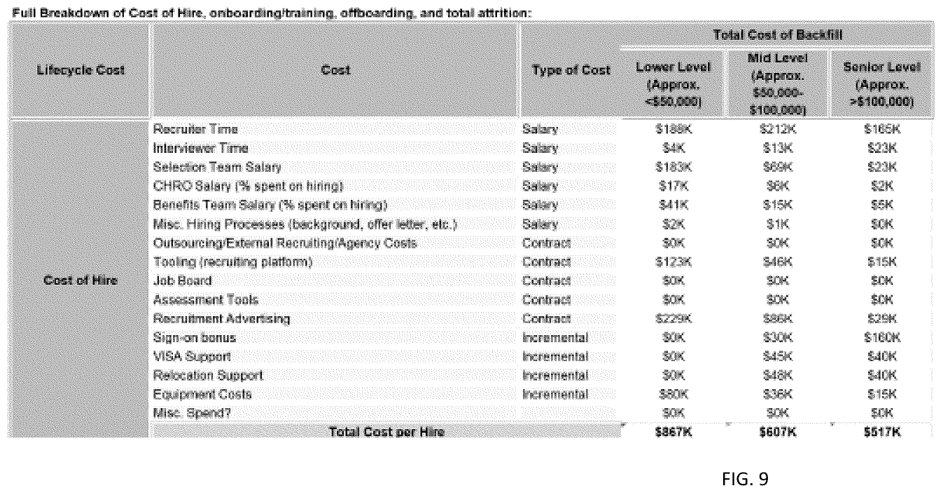

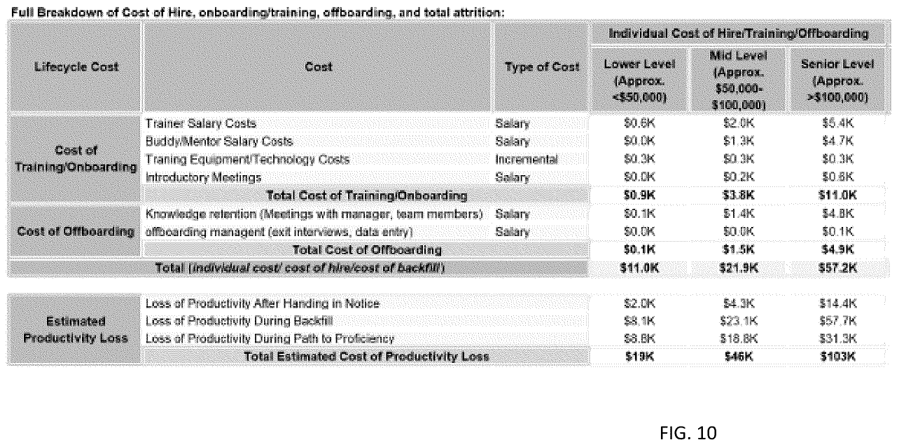

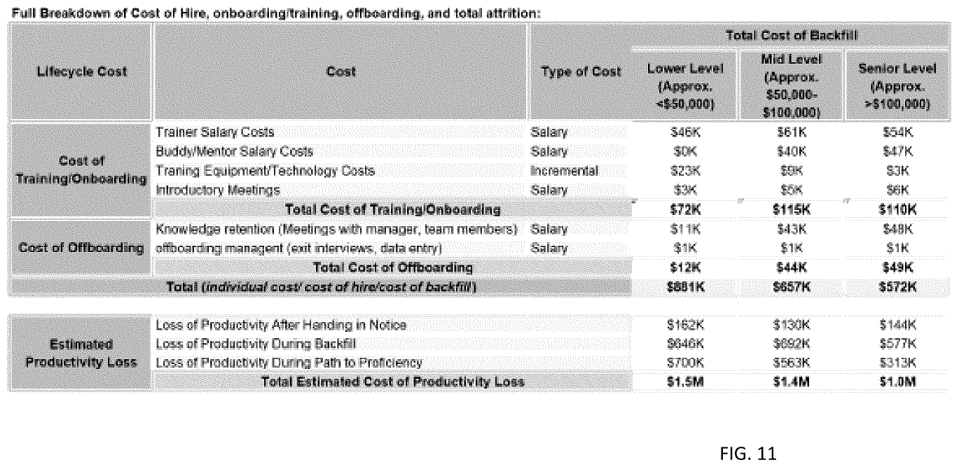

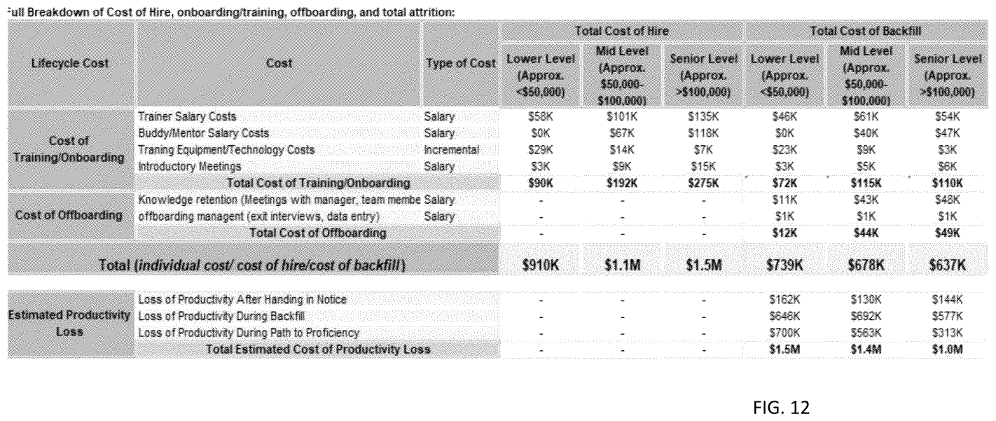

As shown in the sequential depictions of FIGS. 7 through 12, the automated infrastructure 10 calculates and selectively displays full breakdowns of cost of hire calculations onboarding & training calculations, offboarding calculations, total attrition calculations, and estimated productivity losses due to attrition. As in FIG. 7, each component of the cost of hire and the totals thereof are separately set out for each employee tier for individual employees, and each component of the cost of hire and the totals thereof are separately set out for each employee tier organization wide as FIG. 8 depicts. The costs of backfill across an organization at each employee tier are broken down and totaled as in FIG. 9. The individual costs of training & onboarding and offboarding and estimated productivity losses due to employee departures are calculated and displayed as in FIG. 10, and the organization-wide costs of training & onboarding and offboarding and estimated productivity losses due to employee departures are calculated and displayed as in FIG. 11. Different display configurations can be selectively rendered, such as of the costs of training & onboarding and offboarding and estimated productivity losses across an organization due to employee departures, and those can be calculated and displayed together with total costs of hire and backfill to give total attrition costs as in FIG. 12.

With further reference to FIGS. 1 and 3, one using the computer infrastructure 10 can thus selectively cause input data to be transformed automatically to synthesized output regarding employee life cycle costs 16. These costs 16 can be drilled down as to, for instance, total cost per application 34, total cost per hire 36, total cost of training & onboarding 38, total cost of offboarding 40, and total cost of backfill & turnover 42. For each employee life cycle cost 16, totals can be processed, displayed, and reviewed by, for instance, salary cost, contract cost, and incremental cost across an organization, by employment tier, by department, and by some combination thereof.

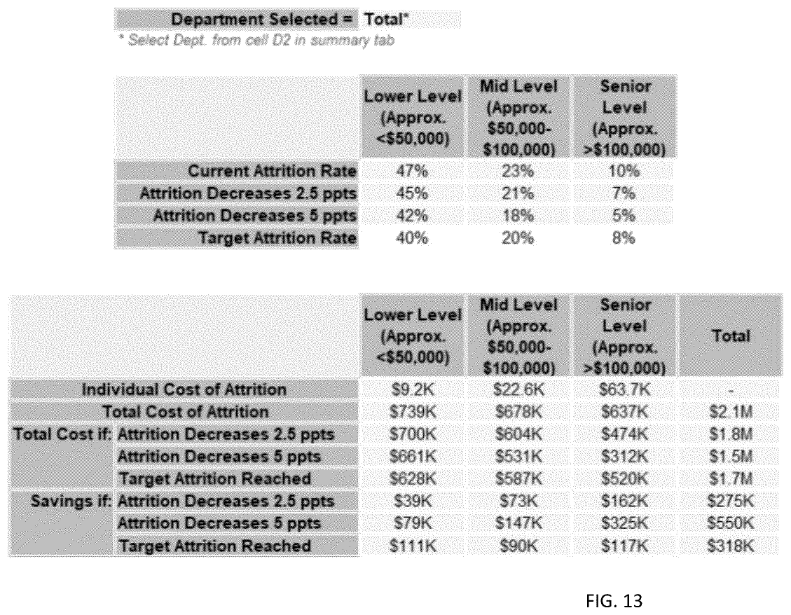

The automated infrastructure 10 is capable of transforming entered data into guidance as to potential cost reductions. For instance, as shown in FIG. 13, with the individual cost of attrition for each employee tier multiplied by the number of departing employees based on attrition rate, the cost of attrition to an organization will be reduced as the organization improves its annual attrition rate. The automated infrastructure 10 automatically calculates and shows, such as in a cost reduction potential tab, percentage and financial savings based on specified percentage reductions in attrition, specifically reductions of 2.5 percent, 5 percent, and a target attrition rate. Potential target attrition rates can be selectively entered, and the resultant savings are automatically calculated and displayed. Savings due to attrition reduction can be viewed across an organization, at individual employment tiers, and, potentially, for individual departments.

Practices of the invention thus provide, among other things, a mechanism to understand the costs and benefits involved in obtaining, retaining, and losing employees and the value that employees bring to an organization. Through, for instance, analysis of the financial impacts of employee attrition, onboarding, offboarding, training, and other human resources aspects and changes thereto, a framework is provided to cause employee decision-making to be better aligned with key corporate strategy. Recruiting, training, and onboarding can be synchronized with baseline data used to improve corporate hiring and retention practices. Human resource personnel are visibly and definably confirmed as high-impact corporate personnel. With the financial impact of employee life cycle costs 16, plans, and actions quantified, human resources decisions can be driven by actual, defined data. Financial impact analyses can be made and updated on an ongoing basis to demonstrate progress, to confirm and publish results, and to promote investment in exploitation of the automated infrastructure 10 disclosed herein. Competitive advantages obtained by use of the automated infrastructure 10 can be readily presented to management and mathematically supported, and the use of the automated infrastructure 10 and method can be performed iteratively to provide ongoing benefits and opportunities for corporate improvement and reinvestment.

As disclosed herein, the cost of each individual hire and total hires can be electronically calculated based, for example, on attributed recruiter time, interviewer time, selection team salaries, chief human resources officer salary, benefits team salary, miscellaneous hiring processes, such as background checks, offer letters, and other processes, outsourcing/external recruiting/agency costs, recruiting platform tooling, job boards and postings, assessment tools, recruitment advertising, sign-on bonuses, VISA support, relocation support, equipment costs, and other miscellaneous expenditures. Expenditures for individual hires can be directly entered, and expenditures applicable to multiple hires can be proportionally determined, entered, and/or analyzed automatically by the automated infrastructure 10. Separately, costs of training/onboarding can be recorded and analyzed by computer within the automated infrastructure based, for example, on trainer salaries, buddy/mentor salaries, training equipment/technology costs, introductory meetings, and other training/onboarding expenditures. Offboarding costs, such as but not limited to knowledge retention through meetings with management and team members and offboarding management through exit interviews and data entry, can be calculated per employee and across the organization. Productivity loss can be estimated based on, for instance, loss of productivity after notice, during backfill, and during a path to proficiency.

Pursuant to the automated infrastructure 10 and method, the data for each individual company and potentially for each individual or specified individuals within the company is processed by computer and employed to fuel decision-making for people-related functions. Past and future spending is evaluated based on return-on-investment, which can be calculated by computer operating dedicated software programming and/or dedicated recording and analysis entries. Actual and projected impacts on business strategy and the bottom line can be analyzed by computer with manual review and prioritized. Strategies are designed based on the retained and analyzed data to reduce performance gaps, reduce expenses, and deliver results. The retained and analyzed data allows the creation of a framework for decision-making that is aligned with the key corporate objectives.

Practices of the automated infrastructure 10 and method for using and implementing the same can employ a five-step strategy, all reliant on the data electronically retained and analyzed according to the present invention. Not necessarily in order, one step comprises defining and quantifying the current state of the company. The current state can be evaluated in a second step based on the actual and/or projected financial impact of potential changes to the current state. In a third step, strategy may be aligned to address high impact actions first. A fourth step involves creating the framework required to ensure success. Finally, a fifth step comprises developing and executing leadership to carry forth the strategy and framework.

Implementation of the disclosed method and infrastructure 10 can incorporate reliance on a practice referred to by the present inventor as the SOAK method. The SOAK method is an acronym formed by the following steps: Stop or Eliminate, Outsource or Delegate, Automate, and Keep or Do. Stop or Eliminate refers to stopping or eliminating items that do not contribute to achieving the company's main goals and identifying and eliminating the cause of firefighting, that is, addressing or attempting to address issues after they become manifest rather than proactively. Outsource or delegate refers to outsourcing or delegating items that can be delivered more efficiently by a vendor and identifying items and practices that can create economies of scale. Automate refers to automating repetitive, value adding tasks that can be done more cost-effectively through automation. Finally, Keep or Do refers to keeping and doing critical items that are identified as delivering high-impact value such that they deserve and demand the time and expense involved.

In practicing the present invention, the organization should be aligned with the two main objectives and reasons for being in business, and each employee should be connected with those overarching organizational goals. Employee goals should be aligned with the critical goals of the organization. In a similar manner, the underlying metrics, actual employee actions, and employee roles should be aligned with employee goals and those critical goals of the organization.

With further reference to FIG. 2, where an employee life cycle 25 is schematically shown, the tools provided by the present method and infrastructure 10 can be employed to understand how each stage in the employee life cycle 25 impacts each prior and subsequent stage. The ability to hire, train, and retain staff efficiently results in competitive advantage. Moreover, retaining and developing the highest performing employees contributes to a successful strategy for consistent high performance. Developing high-performing employees into leadership positions and roles is operative to bring corporate strategies to life.

Ecosystems can be created by use of the retained and processed information to maximize the value of the inventive infrastructure 10 and method to the organization. For instance, a learning North Star ecosystem can be created through a learning ecosystem in combination with a learning management system (LMS) and/or a learning experience platform (LXP). The learning ecosystem can derive from the combined effects of individual skills, adult learning and disciplined designs, brand standards, organizational culture and intent, and modes of delivery. The learning management system (LMS) and/or learning experience platform (LXP) can incorporate and rely on one or more of company created content, digital content, scalable content libraries, social learning, mobile learning, massive open online coursework (MOOC), virtual classrooms and practices, and video portals.

The infrastructure 10 is operative to trap and evaluate by computer all employee life cycle costs 16 to permit use of that data to fuel decision making, to evaluate past and future spending based on return-on-investment, to design strategies to reduce gaps in performance and expenses, and to deliver results to achieve a competitive advantage. Leadership can be developed based on the information acquired by use of the automated infrastructure 10, including the ability to manage return-on-investment and other leadership and human resource functions proactively. Still further, the human resource economic analyses enabled by the present invention can be seen to interrelate with strategic alignments and leadership development and the impact of these factors on organizational results. Identified business objectives, leadership development, and return-on-investment analysis can be better understood for their impact on organizational results.

With certain details and embodiments of the present invention for an automated infrastructure 10 and method for human capital economic analysis and management through employee life cycle cost determination, return on investment examination, and decision making framework disclosed, it will be appreciated by one skilled in the art that numerous changes and additions could be made thereto without deviating from the spirit or scope of the present invention. This is particularly true when one bears in mind that the presented preferred embodiments merely exemplify the broader invention revealed herein. Accordingly, it will be clear that those with major features in mind could craft embodiments that incorporate those major features while not incorporating all of the features included in the preferred embodiments.

Therefore, the following patent claims shall define the scope of protection to be afforded to the invention. Those claims shall be deemed to include equivalent constructions insofar as they do not depart from the spirit and scope of the invention. It must be further noted that a plurality of the following claims may express, or be interpreted to express, certain elements as means for performing a specific function, at times without the recital of structure or material. As the law demands, any such claims shall be construed to cover not only the corresponding structure and material expressly described in this specification but also all legally-cognizable equivalents thereof.

What is claimed as deserving of Letters Patent is:

1. An automated computer infrastructure for synthesizing computer data regarding employee life cycle costs for human capital economic analysis and management, the automated computer infrastructure comprising:
a computerized framework operative to receive and process employee life cycle financial data elements in an automated manner by computer and to transform the life cycle financial data elements into actionable synthesized human resource economic analysis;
wherein the computerized framework comprises computer data entry and analysis software adapted for receiving individual employee and organizational life cycle financial data elements relating to costs of hire, costs of training & onboarding, and costs of offboarding and automatically processing and transforming the individual employee and organizational life cycle financial data elements to yield actionable synthesized human resource economic analysis.

2. The automated computer infrastructure of claim 1, wherein the computerized framework further comprises computer hardware comprising one or more computer processors, data entry components, and electronic memory for retaining the computer data entry and analysis software and employee life cycle financial data elements to be transformed into actionable synthesized human resource economic analysis.

3. The automated computer infrastructure of claim 1, wherein the computerized framework is operative to receive and process employee life cycle financial data elements comprising a number of employee hires for each of plural employee tiers, a number of employee applications for each of the plural employee tiers, a total number of employee applications, and an overall salary of a recruiting department and to transform those life cycle financial data elements in an automated manner by computer to percentage of recruiter time spent on each of the plural employee tiers and recruiter cost per hire for each of the plural employee tiers.

4. The automated computer infrastructure of claim 3, wherein percentage of recruiter time spent on each of the plural employee tiers is automatically calculated by the computerized framework based on the number of employee applications for each employee tier divided by the total number of employee applications.

5. The automated computer infrastructure of claim 4, wherein recruiter cost per hire for each of the plural employee tiers is automatically calculated by the computerized framework based on dividing the percentage of recruiter time spent on each of the plural employee tiers multiplied by the overall salary of the recruiting department by the number of employee hires for each of the plural employee tiers.

6. The automated computer infrastructure of claim 1, wherein the computerized framework is operative to receive and process employee life cycle financial data elements comprising total department salary for a department spending time on hiring, a percentage of time spent by the department spending time on hiring on each of plural employee tiers, a number of employee applications for each of the plural employee tiers, a total number of employee applications, a number of employee hires for each of the plural employee tiers, a total number of employee hires and to transform those life cycle financial data elements in an automated manner by computer to hiring salary overhead for the department spending time on hiring.

7. The automated computer infrastructure of claim 6, wherein the hiring salary overhead for the department spending time on hiring is automatically calculated by the computerized framework based on the formula:
((total department salary for the department spending time on hiring×percentage of time spent by the department spending time on hiring on a respective employee tier)×(number of employee applications for the respective plural employee tier/total number of employee applications))/total number of employee hires.

8. The automated computer infrastructure of claim 1, wherein the computerized framework is operative to receive and process employee life cycle financial data elements comprising total salary for administrative personnel spending time on hiring and hours spent by the administrative personnel on hiring and to transform those life cycle financial data elements in an automated manner by computer to salary time costs for the administrative personnel spending time on hiring.

9. The automated computer infrastructure of claim 8, wherein the salary time costs for the administrative personnel spending time on hiring is automatically calculated by the computerized framework based on the formula:
(total salary for administrative personnel spending time on hiring/2080)×hours spent by the administrative personnel on hiring.

10. The automated computer infrastructure of claim 1, wherein the computerized framework is operative to receive and process employee life cycle financial data elements comprising an average number of interviews per employee, average interview length in hours, average number of interviewers, and average interviewer salary and to transform those life cycle financial data elements in an automated manner by computer into total interview time, hourly cost of interview time, and total cost of interview time.

11. The automated computer infrastructure of claim 10, wherein the total interview time is automatically calculated by the computerized framework based on the formula:
((average number of interviews per employee×average interview length in hours)×average number of interviewers)/60.

12. The automated computer infrastructure of claim 11, wherein the total cost of interview time is automatically calculated by the computerized framework based on the formula:
Total cost of interview time×(average interviewer salary/2080).

13. The automated computer infrastructure of claim 1, wherein the computerized framework is operative to receive and process employee life cycle financial data elements comprising total contract costs for each of plural employee tiers and number of employee hires within each of the plural employee tiers and to transform those life cycle financial data elements in an automated manner by computer into contract costs per employee.

14. The automated computer infrastructure of claim 13, wherein the contract costs per employee is automatically calculated by the computerized framework based on dividing the total contract costs for each of the plural employee tiers by number of employee hires within each of the plural employee tiers.

15. The automated computer infrastructure of claim 1, wherein the computerized framework is operative to receive and process employee life cycle financial data elements comprising average employee trainer salary, number of working days in a year, and average number of days of employee training and to transform those life cycle financial data elements in an automated manner by computer into cost of training per employee.

16. The automated computer infrastructure of claim 15, wherein cost of training per employee is automatically calculated by the computerized framework based on dividing the average employee trainer salary by the number of working days in a year and multiplying the result by the average number of days of employee training.

17. The automated computer infrastructure of claim 1, wherein the computerized framework is operative to receive and process employee life cycle financial data elements comprising an average salary of mentors, number of working days in a year, and average number of days of mentorship and to transform those life cycle financial data elements in an automated manner by computer into a salary cost of mentoring.

18. The automated computer infrastructure of claim 17, wherein the salary cost of mentoring is automatically calculated by the computerized framework based on dividing the average salary of mentors by the number of working days in a year and multiplying the result by the average number of days of mentorship.

19. The automated computer infrastructure of claim 1, wherein the computerized framework is operative to receive and process employee life cycle financial data elements comprising an average salary of employees involved in knowledge retention on employee departure and total hours spent by employees involved in knowledge retention on employee departure and to transform those life cycle financial data elements in an automated manner by computer into a knowledge retention expense.

20. The automated computer infrastructure of claim 19, wherein the knowledge retention expense is automatically calculated by the computerized framework based on dividing the average salary of employees involved in knowledge retention on employee departure by 2,080 and multiplying the result by the total hours spent by employees involved in knowledge retention on employee departure.

21. The automated computer infrastructure of claim 1, wherein the computerized framework is operative to receive and process employee life cycle financial data elements comprising an average salary of employees involved in exit interviews and administrative tasks on employee departure and total hours spent by employees involved in exit interviews and administrative tasks on employee departure and to transform those life cycle financial data elements in an automated manner by computer into an offboarding expense.

22. The automated computer infrastructure of claim 21, wherein the offboarding expense is automatically calculated by the computerized framework based on dividing the average salary of employees involved in exit interviews and administrative tasks on employee departure by 2,080 and multiplying the result by the total hours spent by employees involved in exit interviews and administrative tasks on employee departure.

23. The automated computer infrastructure of claim 1, wherein the computerized framework is operative to receive and process employee life cycle financial data elements comprising average salary for an employee tier, productivity value in relation to employee salary, notice period in weeks, percentage productivity lost following notice of leaving, average time in days to backfill employee position, productivity lost during employee path to proficiency, and time to reach proficiency in months and to transform those life cycle financial data elements in an automated manner by computer into loss of productivity following notice of departure, loss of productivity during backfill, and loss of productivity during path to proficiency.

24. The automated computer infrastructure of claim 23, wherein the loss of productivity following notice is automatically calculated by the computerized framework based on dividing the average salary for an employee tier by 2,080, multiplying the result by the percentage productivity lost following notice of leaving, and multiplying that result by productivity value in relation to employee salary.

25. The automated computer infrastructure of claim 23, wherein the loss of productivity during backfill is automatically calculated by the computerized framework based on multiplying average time in days to backfill employee position by the result of multiplying productivity value in relation to employee salary by average salary for the employee tier.

26. The automated computer infrastructure of claim 23, wherein the loss of productivity during path to proficiency is automatically calculated by the computerized framework based on multiplying productivity value in relation to employee salary by productivity value during path to proficiency and multiplying the result by time to reach proficiency.

27. The automated computer infrastructure of claim 1, wherein the computerized framework is operative to receive and process employee life cycle financial data elements comprising a number of employee hires for each of plural employee tiers, a number of employee departures for each of plural employee tiers, costs of hire, costs of training & onboarding, costs of offboarding, productivity losses, and costs of backfill and to transform those life cycle financial data elements in an automated manner by computer to costs of attrition.

28. The automated computer infrastructure of claim 27, wherein the employee life cycle financial data elements are separated by employee tier and wherein the computerized framework is operative to transform the life cycle financial data elements into costs of attrition by employment tier and in total.

29. The automated computer infrastructure of claim 27, wherein the computerized framework is further operative to determine and display cost reduction potentials due to specified reductions in employee attrition.
